(19) United States
(12) Patent Application Publication
(10) Pub. No.: US 2013/0169008 A1
(43) Pub. Date: Jul. 4, 2013

(54) Vehicle roof comprising a polycarbonate cover

(71) Applicants: Peter Michalsky, Schondorf a. Ammersee (DE); Dominik Hôlzel, Olching (DE); Andreas Lang, Grobenzell (DE); Markus Boss, Regensburg (DE); Jochen Walz, Jetzendorf (DE); Martin Pollak, Puchheim (DE); Wolfgang Dittrich, Hagenheim (DE)

(72) Inventors: Peter Michalsky, Schondorf a. Ammersee (DE); Dominik Hôlzel, Olching (DE); Andreas Lang, Grobenzell (DE); Markus Boss, Regensburg (DE); Jochen Walz, Jetzendorf (DE); Martin Pollak, Puchheim (DE); Wolfgang Dittrich, Hagenheim (DE)

(73) Assignee: Webasto AG, Stockdorf (DE)

(21) Appl. No.: 13/516,516

(22) PCT Filed: Mar. 24, 2011
(86) PCT No.: PCT/EP11/54523

§ 371 Date: Aug. 27, 2012

(30) Foreign Application Priority Data
Mar. 26, 2010 (DE) 10 2010 012 942.9

(51) Int. Cl. B60J 7/043

(52) U.S. Cl. CPC B60J 7/043
USPC 296/216.01

(57) ABSTRACT

A vehicle roof is proposed, comprising a roof opening which may be selectively closed or at least partially opened by means of a cover element, which is guided relative to a vehicle longitudinal central plane on both sides via a drive mechanism in a guide rail fixed to the roof, and which is made from a material comprising polycarbonate. The drive mechanism is at least partially an integral component of the cover element.

The invention relates to a vehicle roof having the features of the preamble of claim 1.

Such a vehicle roof is known from practical experience and comprises a roof opening which may be selectively closed or at least partially opened by means of a cover element. Relative to a vehicle longitudinal central plane the cover element is connected in each case on both sides to a cover support which, for example, comprises a control path on which a drive carriage is guided for adjusting the cover element, said drive carriage being guided in a guide rail fixed to the roof. An actuation of the drive carriage effects a pivoting of the cover element. The pivoting movement is defined by the shape of the control path of the support element. The support element is generally connected via fastening tabs which are connected to the cover element via a foamed-on frame.

The object of the invention is to provide a vehicle roof of the type mentioned in the introduction which is characterized relative to the prior art by short manufacturing times.

This object is achieved according to the invention by the vehicle roof having the features of claim 1.

The essence of the invention is that at least parts of the drive mechanism for the cover element are integral components thereof. This means that said parts of the drive mechanism no longer have to be connected separately to the cover element after the manufacture thereof. Instead, said parts are already fixedly connected after the manufacture of the cover element. As a result, the manufacturing process of the vehicle roof is considerably accelerated.

In a preferred embodiment of the vehicle roof according to the invention, the drive mechanism comprises a cover connecting component which is configured as an insert of the cover element. The cover connecting component is therefore inserted into the injection-molding tool when injection-molding the cover element and is partially enclosed by the polycarbonate material when the cover element is made. Thus a stable connection of the cover connecting component to the cover element exists.

The cover connecting component may, in particular, be a cover support which comprises a control path for a drive carriage guided in the relevant guide rail. The shape of the control path provides a pivoting movement of the cover element when the drive carriage is actuated.

In an alternative embodiment of the vehicle roof according to the invention, the drive mechanism comprises a cover connecting component which is produced integrally with the cover element. In this case, therefore, the cover connecting component also consists of a polycarbonate material or a different plastics material, which may be connected to the polycarbonate of the cover element by an injection-molding process. In this case, the cover element forms with the directly connected cover connecting component a multi-component plastics injection-molded component which may be produced in a corresponding tool.

Further advantages and advantageous embodiments of the subject of the invention are able to be derived from the description, the drawings and the claims.

An exemplary embodiment of a vehicle roof according to the invention is shown schematically in simplified form in the drawings and is described in more detail in the following description, in which:

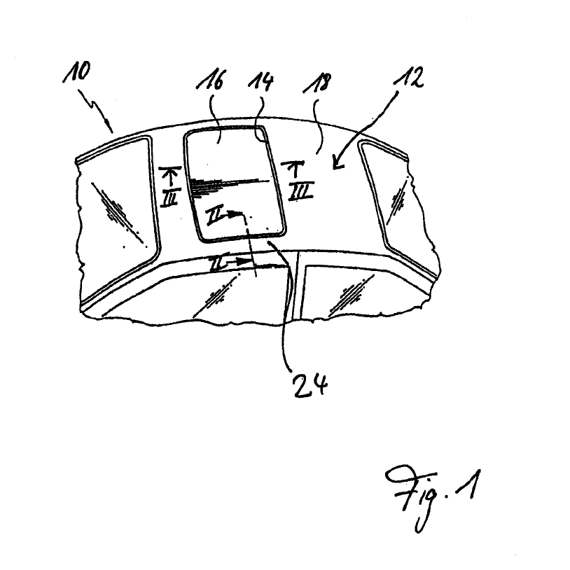

FIG. 1 shows a perspective plan view of a vehicle roof according to the invention;

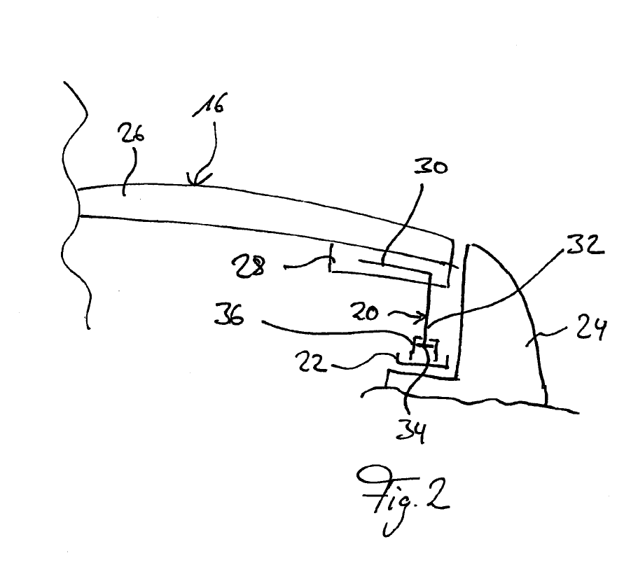

FIG. 2 shows a very schematic section along the line II-II in FIG. 1; and

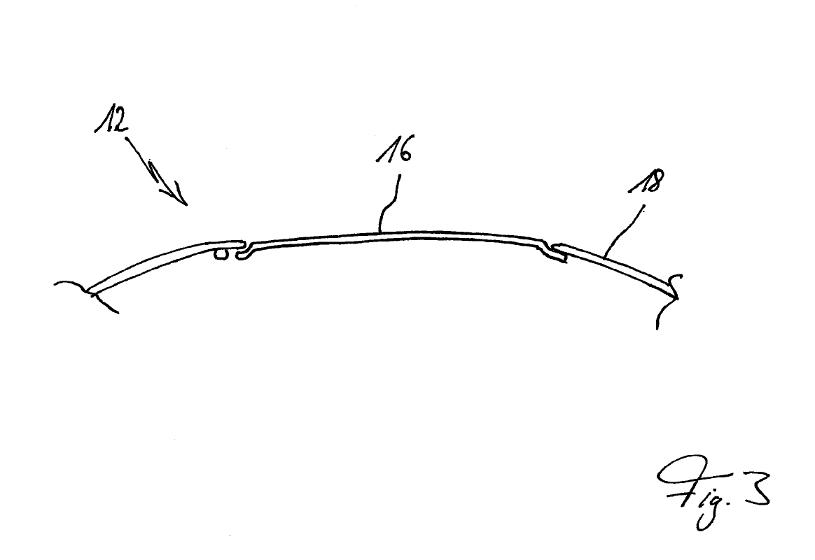

FIG. 3 shows a very schematic longitudinal section through the vehicle roof along the line III-III in FIG. 1.

A passenger motor vehicle 10 is shown in the drawings, said passenger motor vehicle comprising a vehicle roof 12 which is provided with a roof opening 14. The roof opening 14 may be selectively closed or at least partially opened by means of a transparent cover element 16 which is a component of a roof opening system. In the present case, the cover element 16 is a component of a sun roof so that when the roof opening is opened, it is moved below a rear fixed roof portion 18.

For adjusting the cover element 16, the vehicle roof 12 comprises in each case a drive mechanism 20 on the lateral edges of the cover element 16 relative to a vertical vehicle longitudinal central plane, said drive mechanism being guided in a guide rail 22 extending in the vehicle longitudinal direction and fixed to the vehicle. The guide rail 22 is mounted in the region of a lateral longitudinal roof member 24.

The cover element 16 is produced as a two-component injection-molded component made of a material comprising polycarbonate and comprises a first, transparent polycarbonate portion 26 which is of planar and transparent configuration. Moreover, the cover element 16 has a second polycarbonate portion 28 arranged in a frame-like manner on the underside of the first polycarbonate portion 26, said second polycarbonate portion being configured to be substantially opaque and extending along the periphery of the edge of the first polycarbonate portion 26.

In order to connect the cover element 16, a cover support 30 configured as an insert is embedded in the second polycarbonate portion 28, wherein a portion 32 of the cover support 30 protruding vertically downwards on its lower edge comprises a control path 34 for a drive carriage 36 of the drive mechanism 20. The drive carriage 36 is guided in the vehicle longitudinal direction in the guide rail 22 fixed to the roof.

The cover support 30, which forms a component of the drive mechanism 20, thus forms an integrated component of the cover element 16 made from polycarbonate. A separate connection of a cover element support to the cover element via screw connections and the like is dispensed with in the vehicle roof configured within the meaning of the invention.

### List of Reference Numerals

10 Passenger Motor Vehicle

12 Vehicle Roof

14 Roof Opening

16 Cover Element

18 Fixed Roof Portion

20 Drive Mechanism

22 Guide Rail

24 Longitudinal Roof Member

26 First Polycarbonate Portion

28 Second Polycarbonate Portion

30 Cover Support

32 Portion

34 Control Path

36 Drive Carriage

1. A vehicle roof, comprising:
a roof opening, which may be selectively closed or at least partially opened by means of a cover element, which is guided relative to a vehicle longitudinal central plane on both sides via a drive mechanism in a guide rail fixed to the roof, and which is made from a material comprising polycarbonate,
wherein the drive mechanism is at least partially an integral component of the cover element.

2. The vehicle roof of claim 1, wherein a cover connecting component of the drive mechanism is configured as an insert of the cover element.

3. The vehicle roof of claim 2, wherein the cover connecting component is a cover support with a control path for a drive carriage guided in the relevant guide rail.

4. The vehicle roof of claim 2, wherein a cover connecting component of the drive mechanism is produced integrally with the cover element.
